(19) United States
(12) Patent Application Publication
(10) Pub. No.: US 2008/0045254 A1
(43) Pub. Date: Feb. 21, 2008

(54) Method and Apparatus for Maximizing Resource Utilization of Base Stations in a Communication Network

(75) Inventors: Anil Gupta, Phoenix, AZ (US); Fredrick J. Bontemps, Phoenix, AZ (US); Roman S. Ebert, Phoenix, AZ (US); George A. Mendez, Chandler, AZ (US)

Correspondence Address: MOTOROLA, INC., LAW DEPARTMENT, 1303 E. ALGONQUIN ROAD, SCHAUMBURG, IL, 60196, US

(73) Assignee: MOTOROLA, INC., Schaumburg, IL (US)

(21) Appl. No.: 11/464,582

(22) Filed: Aug. 15, 2006

(51) Int. Cl. H04Q 7/20; H04B 7/00

(52) U.S. Cl. 455/509; 455/450

(57) ABSTRACT

A method for allocating at least one resource of one or more base stations in a communication network (200) is provided. The method includes connecting (404) a set of base stations to one or more Common Public Radio Interface (CPRI) switches (102) in the communication network. The method also includes connecting (406) a set of radio heads to the one or more CPRI switches. Further, the method includes allocating (408) the at least one resource of the one or more base stations in the communication network through the one or more CPRI switches.

The present invention generally relates to a communication networks, and more specifically, to a method and an apparatus for maximizing resources of base stations in a communication network. This invention provides a device and connection methodology for connecting resources of a BTS or multiple BTSs such that the capacity resources across an operator's network can be reallocated or distributed.

### BACKGROUND OF THE INVENTION

Base stations play a pivotal role in a communication network. The base stations enable communication devices, for example, mobile phones and personal digital assistants (PDA), in the communication network to communicate with each other. Examples of the base stations include, but are not limited to, Code Division Multiple Access (CDMA) base stations, Global System for Mobile Communications (GSM) base stations, Universal Mobile Telecommunications System (UMTS) base stations, Wireless Broadband (WiBB) base stations, and other wireless access point technology base stations. A base station consists of modems, remote heads, equipment space, electrical supply, batteries, and air conditioning. Typically, a base station is designed to support one or more users simultaneously for voice or data traffic. The one or more users can be referred to as BTS capacity of the base station. When the base station can no longer support further voice or data calls, it indicates that one or more BTS resources are not available for additional voice or data calls. A high-traffic site is a site where high numbers of users are accessing the network simultaneously.

Typically a base station can include one or more controller cards, one or more CDMA clock synchronization cards, one or more Modem cards, one or more Remote Heads, and one or more local oscillators. Such elements add to the complexity and total cost of the base station, since these elements need to be employed by each base station in the communication network. According to current methods, base stations in the communication network are not capable of sharing resources with each other. As a result, the base stations are sometimes also referred to as localized base stations. Capacity related problems can arise when a base station utilizes most of its resources simultaneously, for example, at a high-traffic site. It is therefore desirable to manage and share the resources of the base stations in the communication network so that resources from the under-used sites can be utilized by high-traffic sites when capacity related problems arise.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention:

FIG. 1 illustrates a Common Public Radio Interface (CPRI) switch, in accordance with various embodiments of the present invention;

FIG. 2 illustrates an exemplary way of connecting a set of base stations and a set of radio heads to a CPRI switch, in accordance with some embodiments of the present invention;

FIG. 3 is a flow diagram illustrating a method for allocating at least one resource of one or more base stations in a communication network, in accordance with some embodiments of the present invention;

FIG. 4 is a flow diagram illustrating a method for allocating at least one resource of one or more base stations in a communication network, in accordance with various embodiments of the present invention;

FIG. 5 illustrates an exemplary way of providing redundant connection to a set of base stations and a set of radio heads to one or more CPRI switches for allocating at least one resource of one or more base stations in a communication network, in accordance with another embodiment of the present invention;

FIG. 6 illustrates another exemplary way of connecting one or more CPRI switches for extending number of base stations and radio heads connections for allocating at least one resource of one or more base stations in a communication network, in accordance with yet another embodiment of the present invention;

FIG. 7 illustrates an exemplary way of connecting a set of modems and a set of radio heads to one or more CPRI switches for allocating at least one resource of one or more base stations in a communication network, in accordance with still another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help to improve an understanding of embodiments of the present invention.

### DETAILED DESCRIPTION

Before describing in detail the particular method and an apparatus for maximizing resource utilization of base stations in a communication network, in accordance with various embodiments of the present invention, it should be observed that the present invention resides primarily in combinations of method steps related to maximizing resource utilization of base stations in a communication network. Accordingly, the apparatus components and method steps have been represented, where appropriate, by conventional symbols in the drawings, showing only those specific details that are pertinent for understanding the present invention, so as not to obscure the disclosure with details that will be readily apparent to those with ordinary skill in the art, having the benefit of the description herein.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such a process, method, article, or apparatus. An element proceeded by “comprises . . . a” does not, without more constraints, preclude the existence of additional identical elements in the process, method, article, or apparatus that comprises the element.

A “set”, as used in this document, means a non-empty set, i.e., comprising at least one member. The term “another,” as used in this document, is defined as at least a second or more. The terms “includes” and/or “having”, as used herein, are defined as comprising.

In an embodiment, a method and an apparatus for allocating at least one resource of one or more base stations in a communication network is provided. The method includes connecting a set of base stations to one or more Common Public Radio Interface (CPRI) switches in the communication network. The method also includes connecting a set of radio heads to the one or more CPRI switches. Moreover, the method includes allocating the at least one resource of the one or more base stations in the communication network through the one or more CPRI switches.

In another embodiment, a method and an apparatus for allocating at least one resource of one or more base stations in a communication network is provided. The method includes housing the at least one resource in a distributed fashion. The method also includes connecting a set of base stations to one or more Common Public Radio Interface (CPRI) switches in the communication network. The method further includes connecting a set of radio heads to the one or more Common Public Radio Interface (CPRI) switches in the communication network. Moreover, the method includes allocating at least one resource of the one or more base stations in the communication network through the one or more CPRI switches. Further, the method includes synchronizing the set of base stations to a master timing reference signal. The master timing reference signal is furnished by a CPRI switch of the one or more CPRI switches.

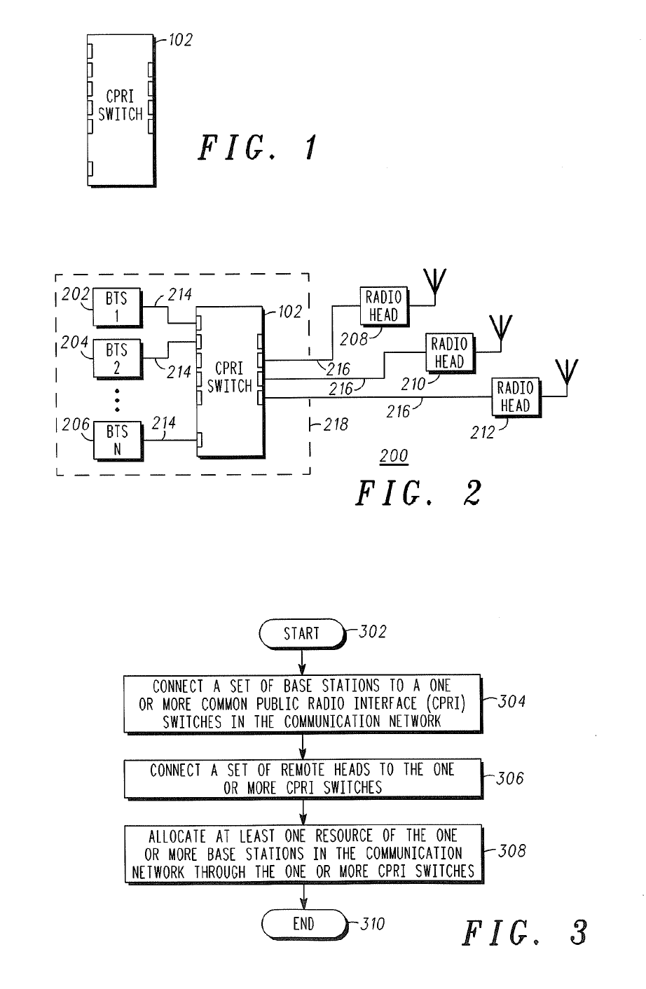

FIG. 1 is a block diagram illustrating a Common Public Radio Interface (CPRI) switch 102, in accordance with various embodiments of the present invention. The CPRI switch 102 can be used to connect one or more base stations to enable resource sharing between the one or more base stations through electrical or fiber optic cables. Examples of the one or more base stations can be Code Division Multiple Access (CDMA) base stations, a Global System for Mobile Communications (GSM) base stations, a Universal Mobile Telecommunications System (UMTS) base stations, and a Wireless Broadband (WiBB) base stations. Each of the one or more base stations can include one or more controller cards, one or more CDMA clock synchronization cards, one or more Modem cards, and one or more local oscillators. Further, the CPRI switch 102 can also be connected to one or more Radio Heads (RHs) or Radio Equipments (REs) through at least one electrical or fiber optics cables. For an embodiment of the present invention, the one or more RHs or REs can transmit and receive the communication network data. In this embodiment, the one or more RHs and REs can behave like a base station.

Typically, a base station is designed to support one or more users simultaneously for voice or data traffic. The one or more users can be referred to as BTS Capacity of the base station. Capacity related problems arise in a base station when at least one resource of the one or more resources of the base station is exhausted. The CPRI switch 102 is based on Time Division Multiplexing (TDM) switch architecture. Further, the CPRI switch 102 is capable of configuring itself according to the way in which the one or more base stations are connected to the one or more RHs or REs. As a result, the CPRI switch 102 can be used for allocating resources of the one or more base stations. Thereby, the high-traffic sites become capable of utilizing the resources of under-used base stations. Further, the CPRI switch 102 is non-blocking and may utilize some level of buffering to accommodate plesiosynchronous data transfers. It enables dedicated time slot for each resource of a base station. For an embodiment of the present invention, the CPRI switch 102 can be connected to one or more CPRI switches. In this embodiment, the number of base stations, modem cards, and RHs connected in the communication network can be increased. Further, the CPRI switch 102, the one or more base stations, and the one or more RHs or REs are synchronized with the same clock. They can select a master timing for synchronizing their clocks from an REC of the one or more RECs or a CPRI switch of the one or more CPRI switches. For another embodiment of the present invention, the CPRI switch 102 provides aggregation, switching, and distribution of baseband data between the one or more resources.

FIG. 2 illustrates an exemplary way of connecting a set of base stations and a set of RHs to a CPRI switch 102 in a communication network 200, in accordance with various embodiments of the present invention. The communication network 200 includes a first base station 202, a second base station 204, and a third base station 206. The first base station 202, the second base station 204, and the third base station 206 can be connected to the CPRI switch 102 through a plurality of electrical or fiber optic cables 214. Further, the CPRI switch 102 is connected to a first RH 208, a second RH 210, and a third RH 212. The first RH 208, the second RH 210, and the third RH 212 can be connected to the CPRI switch 102 through one or more electrical or fiber optic cables 216. For an embodiment of the present invention, the first base station 202, the second base station 204, the third base station 206, and the CPRI switch 102 can be housed in a single central location 218. The central location 218 can then serve as a base station of larger capacity or as a centralized base station hotel. For another embodiment of the present invention, the communication network 200 can include 2N or N+1 additional CPRI switches for redundancy.

The CPRI switch 102 can be utilized by high-traffic sites for sharing resources of under-used base stations. For example, if the first base station 202 is a high-traffic site and the second base station 204 is an under-used site, then resources of the second base station 204 can be shared by the first base station 202. For another embodiment of the present invention, the central location 218 can house a plurality of CPRI switches, as well as the first base station 202, the second base station 204, and the third base station 206. The plurality of CPRI switches can be connected with each other to connect to additional base stations.

FIG. 3 is a flow diagram illustrating a method for allocating at least one resource of one or more base stations in the communication network 200, in accordance with some embodiments of the present invention. The method begins at step 302. At step 304, a set of base stations are connected to one or more CPRI switches in, for example, the communication network 200. For example, the first base station 202, the second base station 204, and the third base station 206 are connected to the CPRI switch 102 through one or more electrical or fiber optic cables 214. The one or more base stations in the communication network 200 include the first base station 202, the second base station 204, and the third base station 206. For one embodiment of the present invention, the one or more CPRI switches and the set of base stations can be housed in the central location 218.

At step 306, a set of RHs are connected to the one or more CPRI switches through at least one of electrical or fiber optic cable. Clocks of the first base station 202, the second base station 204, the third base station 206, and of the one or more CPRI switches are synchronized with each other. The clocks are synchronized to a master timing from an REC of the one or more RECs or a CPRI switch of the one or more CPRI switches.

At step 308, the at least one resource of the first base station 202, the second base station 204, and the third base station 206 in the communication network 200 is allocated through the one or more CPRI switches. As described earlier, the first RH 208, the second RH 210, as well as the third RH 212 can be connected in the communication network 200 by using the at least one of electrical or fiber optic cable. For an embodiment of the present invention, the at least one resource can be housed in a distributed fashion, for example, the at least one resource can be utilized by one of the base station of the first base station 202, the second base station 204, and the third base station 206. Thereafter, the method terminates at step 310.

FIG. 4 is a flow diagram illustrating a method for allocating at least one resource of one or more base stations in a communication network 200, in accordance with various embodiments of the present invention. The method begins at step 402. At step 404, the at least one resource is housed in a distributed fashion. The at least one resource that is housed in a distributed fashion can be utilized by any base station of the one or more base stations. At step 406, a set of base stations are connected to one or more CPRI switches in the communication network 200. For example, the first base station 202, the second base station 204, and the third base station 206 are connected to the CPRI switch 102. The one or more base stations in the communication network 200 include the first base station 202, the second base station 204, and the third base station 206. For an embodiment of the present invention, the one or more CPRI switches, the first base station 202, the second base station 204, and the third base station 206 can be housed in the central location 218.

At step 408, first RH 208, the second RH 210, and the third RH 212 are connected to the one or more CPRI switches through the at least one electrical or fiber optic cable. The first base station 202, the second base station 204, the third base station 206, and the one or more CPRI switches can be synchronized to a master timing reference signal. At step 410, the at least one resource of the one or more base stations in the communication network 200 is allocated through the one or more CPRI switches. The first RH 208, the second RH 210, and the third RH 212 can receive and transmit the communication network data similar to a base station of the one or more base stations. At step 412, the first base station 202, the second base station 204, and the third base station 206, as well as the one or more CPRI switches are synchronized with a master timing reference signal. The master timing reference signal can be furnished by a CPRI switch of the one or more CPRI switches or an alternative resource. Examples of alternative resources include, but are not limited to, base stations, modems, and RHs. The method terminates at step 414.

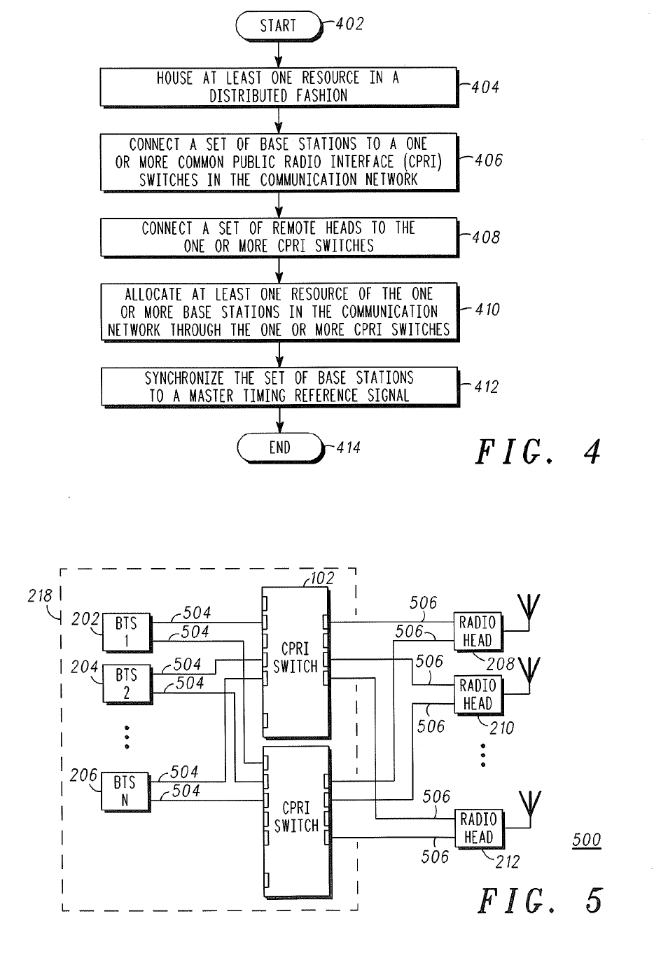

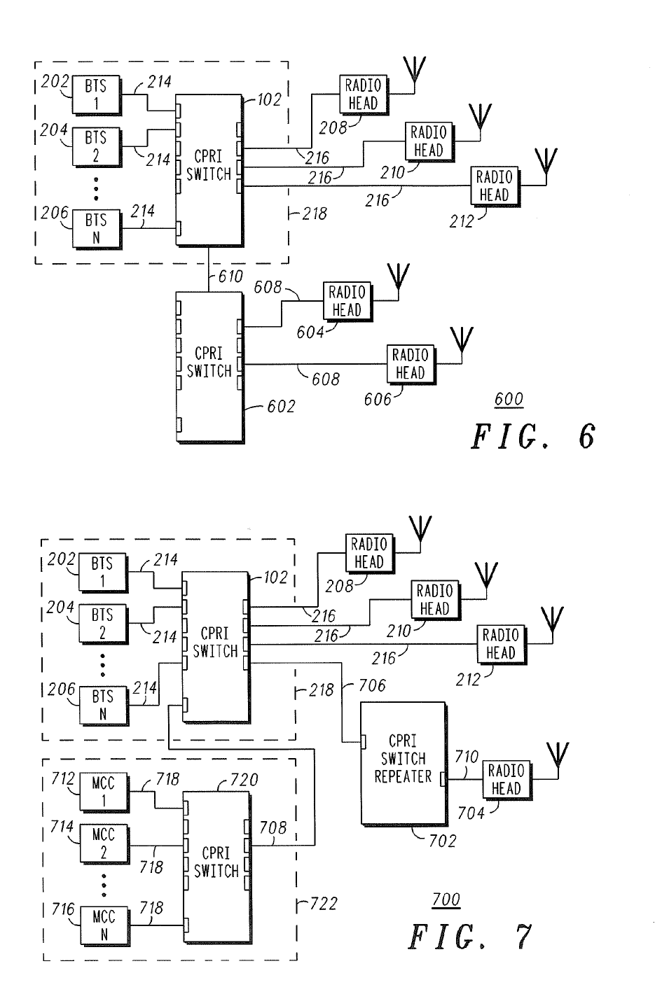

FIG. 5 illustrates an exemplary way of connecting the first base station 202, the second base station 204, and the third base station 206 and first RH 208, the second RH 210, and the third RH 212 to the one or more CPRI switches for allocating at least one resource of one or more base stations in the communication network 500, in accordance with an embodiment of the present invention. The communication network 500 includes the first base station 202, the second base station 204, and the third base station 206. Further, the communication network 500 includes a plurality of CPRI switches. Further, the communication network 500 is shown to include the CPRI switch 102 and a second CPRI switch 502. The first base station 202, the second base station 204, and the third base station 206 can be connected to the CPRI switch 102 and the second CPRI switch 502 through a plurality of electrical or fiber optic cables 504.

The communication network 500 also includes the first RH 208, the second RH 210, and the third RH 212. The first RH 208, the second RH 210, and the third RH 212 are connected to the CPRI switch 102 and the second CPRI switch 502 through a plurality of electrical or fiber optic cables 506. For an embodiment of the present invention, the first base station 202, the second base station 204, and the third base station 206 and the CPRI switch 102 and the second CPRI switch 502 can be housed in the central location 218. The CPRI switch 102 and the second CPRI switch 502 can be connected to the first RH 208, the second RH 210, and the third RH 212 through a plurality of electrical or fiber optic cables 506. For another embodiment of the present invention, the CPRI switch 102 and the second CPRI switch 502 can be connected to additional CPRI switches. Each of the additional CPRI switches can then be connected to additional base stations and additional RHs to increase the number of base stations and RHs connected in the communication network 500.

FIG. 6 illustrates another exemplary way of connecting the first base station 202, the second base station 204, and the third base station 206 as well as the first RH 208, the second RH 210, and the third RH 212 to at least one CPRI switch for allocating at least one resource of one or more base stations in a communication network 600, in accordance with another embodiment of the present invention. The CPRI switch 102 can also be connected through an electrical or fiber optic cable 610 to a remote CPRI switch 602. Further, the remote CPRI switch 602 can be connected through the plurality of electrical or fiber optic cables 608 to a fourth RH 604 and a fifth RH 606. The first base station 202, the second base station 204, and the third base station 206 can then distribute the communication network data to the forth RH 604 and a fifth RH 606. The fourth RH 604 and the fifth RH 606 can then radiate and receive the communication network data and can behave like another base station.

FIG. 7 illustrates an exemplary way of connecting the first base station 202, the second base station 204, and the third base station 206 as well as the first RH 208, the second RH 210, and the third RH 212 to one or more CPRI switches for allocating at least one resource of one or more base stations in a communication network 700, in accordance with another embodiment of the present invention. The CPRI switch 102 can be connected to a CPRI switch repeater 702 by using an electrical or fiber optic cable 706. The CPRI switch repeater 702 can be connected to additional RHs to extend the transmission link range between the one or more base stations or a set of modem cards with the additional RHs. The set of modem card includes a first modem card 712, a second modem card 714, and a third modem card 716. The CPRI switch repeater 702 is shown to be connected to an RH 704 by using an electrical or fiber optic cable 710. For an embodiment of the present invention, the CPRI switch 102 can be connected to one or more CPRI switch repeaters, wherein each of the one or more CPRI switch repeaters can be connected to additional RH. Further, the CPRI switch 102 can also be connected to a second CPRI switch 720 through an electrical or fiber optic cable 708. The second CPRI switch 720 can be connected to the first modem card 712, the second modem card 714, and the third modem card 716 by using a plurality of electrical or fiber optic cables 718. For an embodiment of the present invention, the second CPRI switch 720 and the first modem card 712, a second modem card 714, and a third modem card 716 can be housed in a second central location 722. The second central location 722 can also house additional CPRI switches and a plurality of base stations which are connected to the additional CPRI switches. Each CPRI switch of the additional CPRI switches can be connected to one or more RHs. In the FIG. 7, the CPRI switch 102, the CPRI switch repeater 702, and the second CPRI switch 720 allow plesiosynchronous data communication. In case of plesiosynchronous data communication, different components of the communication network 700 are synchronized with a single clock. For example, to enable plesiosynchronous data communication the first base station 202, the second base station 204, the third base station 206, the CPRI switch 102, the CPRI switch repeater 702, the second CPRI switch 720, the first modem card 712, the second modem card 714, the third modem card 716, the first RH 208, the second RH 210, and the third RH 212 are synchronized to the same master timing reference signal. As a result, their clocks are synchronized to one another and aligned to the data stream. For another embodiment of the present invention, baseband data plane is allowed for each of the CPRI switch 102, the CPRI switch repeater 702, and the second CPRI switch 720.

Various embodiments of the present invention provide a method for allocating resources of one or more base stations. The method enables redistribution of resources from under-used sites to high-traffic sites by the use of CPRI switches. The method also reduces cost of installing elements in base stations such as infrastructure, air conditioning, electrical supply, batteries and the like by enabling redistribution of resources from an under-used base station to a high-traffic site. In accordance with an embodiment, the overall capacity of a set of base stations can be increased by effective utilization of resources of various base stations. Moreover, the method allows for integration of different types of base stations within the same network as the CPRI switches can connect to different type of base stations.

It will be appreciated that the method and system for allocating resources of base stations in a communication network described herein may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of a method to enable users to view a broadcasted media stream differently. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention, as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application, and all equivalents of those claims as issued.

What is claimed is:

1. A method for allocating at least one resource of one or more base stations in a communication network, the method comprising:
connecting a set of base stations to one or more Common Public Radio Interface (CPRI) switches in the communication network, wherein the one or more base stations comprise the set of base stations;
connecting a set of radio heads to the one or more CPRI switches, wherein the set of radio heads are in the communication network; and
allocating the at least one resource of the one or more base stations in the communication network through the one or more CPRI switches.

2. The method as recited in claim 1 further comprising connecting a set of modem cards to the one or more CPRI switches.

3. The method as recited in claim 1 further comprising housing the at least one resource in a distributed fashion.

4. The method as recited in claim 1 further comprising synchronizing the set of base stations to a master timing reference signal, wherein the master timing reference signal is furnished by a CPRI switch of the one or more CPRI switches or an alternative resource.

5. The method as recited in claim 1 further comprising connecting the one or more CPRI switches to additional CPRI switches.

6. The method as recited in claim 1 further comprising connecting the additional CPRI switches to additional resources.

7. The method as recited in claim 1, wherein the one or more base stations are selected from a group comprising Code Division Multiple Access (CDMA) base stations, Global System for Mobile Communications (GSM) base stations, Universal Mobile Telecommunications System (UMTS) base stations, Wireless Broadband (WiBB) base stations and other wireless access point technology base stations.

8. The method as recited in claim 1 further comprising connecting one or more Radio Equipment Controllers (REC's) and one or more Radio Equipments (RE's) resources to each of the one or more CPRI switches.

9. The method as recited in claim 1, wherein 2N or N+1 CPRI switches are configured in a network to provide redundancy.

10. The method as recited in claim 1 further comprising allowing plesiosynchronous data communication in control and baseband data plane in each of the one or more CPRI switches.

11. The method as recited in claim 1, wherein each of the one or more CPRI Switches provides aggregation, switching and distribution of baseband data between resources.

12. The method as recited in claim 1 further comprising connecting additional CPRI switch to the one or more CPRI switches to extend the transmission link range between resources or to provide connection of additional resources.

13. A method for allocating at least one resource of one or more base stations in a communication network, the method comprising:
housing the at least one resource in a distributed fashion;
connecting a set of base stations to one or more Common Public Radio Interface (CPRI) switches in the communication network;
connecting a set of radio heads to the one or more CPRI switches, wherein the set of radio heads are in the communication network;
allocating the at least one resource of the one or more base stations in the communication network through the one or more CPRI switches; and
synchronizing the set of base stations to a master timing reference signal, wherein the master timing reference signal is furnished by a CPRI switch of the one or more CPRI switches or an alternative resource.

14. The method as recited in claim 13 further comprising connecting a set of modem cards to the one or more CPRI switches.

15. The method as recited in claim 13 further comprising connecting the one or more CPRI switches to additional CPRI switches.

16. The method as recited in claim 13 further comprising connecting the additional CPRI switches to additional resources.

17. The method as recited in claim 13, wherein the one or more base stations are selected from a group comprising Code Division Multiple Access (CDMA) base stations, Global System for Mobile Communications (GSM) base stations, Universal Mobile Telecommunications System (UMTS) base stations, Wireless Broadband (WiBB) base stations and other wireless access point technology base stations.

18. The method as recited in claim 13 further comprising connecting one or more Radio Equipment Controllers (REC's) and one or more Radio Equipments (RE's) resources to each of the one or more CPRI switches.

19. The method as recited in claim 13 further comprising allowing plesiosynchronous data communication in control and baseband data plane in each of the one or more CPRI switches.

20. The method as recited in claim 13, wherein the one or more CPRI Switches provides aggregation, switching and distribution of baseband data between resources.

21. The method as recited in claim 13 further comprising connecting additional CPRI switch to the one or more CPRI switches to extend the transmission link range between resources or to provide connection of additional resources.

22. The method as recited in claim 13, wherein 2N or N+1 CPRI switches are configured in a network to provide redundancy.
